(19) United States
(12) Patent Application Publication
(10) Pub. No.: US 2020/0116089 A1
(43) Pub. Date: Apr. 16, 2020

(54) AIR CONTROL APPARATUS FOR AN ENGINE AND A METHOD THEREOF

(71) Applicants: HYUNDAI MOTOR COMPANY, Seoul (KR); KIA MOTORS CORPORATION, Seoul (KR)

(72) Inventor: Jang Hun Kim, Suwon-si (KR)

(73) Assignees: HYUNDAI MOTOR COMPANY, Seoul (KR); KIA MOTORS CORPORATION, Seoul (KR)

(21) Appl. No.: 16/257,507

(22) Filed: Jan. 25, 2019

(30) Foreign Application Priority Data
Oct. 11, 2018 (KR) 10-2018-0120875

(51) Int. Cl. F02D 41/00; F02B 3/08; F02B 33/44; F02B 37/04

(52) U.S. Cl. CPC F02D 41/0002; F02B 3/08; F02B 37/12; F02B 37/04; F02B 33/446

(57) ABSTRACT

An air control apparatus for an engine includes, an air injector that sprays air circumferentially into a combustion chamber, a pneumatic pressure supplier that supplies compressed air to the air injector, and a controller that controls the pneumatic pressure supplier to supply compressed air to the air injector after closing an intake valve of the engine.

### CROSS REFERENCE TO RELATED APPLICATION

The present application claims priority to and the benefit of Korean Patent Application No. 10-2018-0120875, filed Oct. 11, 2018, the entire contents of which are incorporated herein for all purposes by this reference.

### BACKGROUND

### 1. Field of the Disclosure

The present disclosure relates to controlling air that is supplied to an engine to burn fuel.

### 2. Description of the Prior Art

A diesel engine is configured to obtain power by suctioning and compressing air and then spraying fuel so that the fuel ignites and burns by itself.

Accordingly, the sprayed fuel and the air should be very quickly and smoothly mixed for efficient combustion of the sprayed fuel. Mixing of the fuel and the air considerably depends on the spray characteristics of an injector and the flow characteristics of the suctioned air.

Swirl, as used herein, means the flow of air circumferentially circulating in a combustion chamber of the flow characteristics of the suctioned air, Swirl has a large influence on mixing of fuel and air.

In order to generate swirl in a combustion chamber in the related art, various valves are used in an intake port or a method of forming an intake port and an intake valve seat in shapes that are advantageous for generating swirl. However, these fundamentally have a side effect that increases resistance in intake air flow, makes an apparatus more complicated, and remarkably increases the manufacturing cost of an engine.

The description provided above as related art of the present disclosure is to help understand the background of the present disclosure and should not be construed as necessarily being included in the related art known by those having ordinary skill in the art.

### SUMMARY

The present disclosure is made in order to solve the above-mentioned problems in the prior art. An aspect of the present disclosure is to provide an air control apparatus for an engine and a method thereof whereby the apparatus and method can improve the power of an engine, can largely reduce noxious exhaust substances, and can improve fuel efficiency. The disclosed air control apparatus and method achieve these results by appropriately generating swirl in desired states in the combustion chamber of an engine without increasing resistance in intake air flow in accordance with the operation states of the engine so that combustion characteristics of the engine can be considerably improved.

In accordance with an aspect of the present disclosure, an air control apparatus is provided for an engine. The apparatus includes: an air injector that sprays air circumferentially into a combustion chamber; a pneumatic pressure supplier that supplies compressed air to the air injector; and a controller that controls the pneumatic pressure supplier to supply compressed air to the air injector after closing an intake valve of the engine.

The air injector may be disposed above the combustion chamber to spray compressed air toward an exhaust port between an intake port and the exhaust port.

The pneumatic pressure supplier may include an air pump that compresses air that has passed through an air cleaner and that supplies the compressed air to the air injector.

The pneumatic pressure supplier may further include an air tank that keeps or stores the compressed air produced by the air pump and supplies the compressed air to the air injector.

The controller may control the air injector to spray compressed air into the combustion chamber while pressure in the combustion chamber is lower than pressure of the compressed air that is supplied from the air pump after the intake valve of the engine is closed.

In accordance with another aspect of the present disclosure, a method of controlling the air control apparatus is provided for the engine. The method includes: receiving operation information of the engine by means of the controller; determining whether the current operation period of the engine is a period when the air injector for generating swirl is required to be operated on the basis of the received operation information by means of the controller; and generating swirl by spraying compressed air into the combustion chamber by operating the air injector by means of the controller when it is determined that the air injector is required to be operated.

The method may further include comparing combustion chamber pressure with a predetermined reference pressure so that the controller operates the air injector to spray compressed air into the combustion chamber only when the combustion chamber pressure is less than the predetermined reference pressure even though the controller determines that the current operation period of the engine corresponds to the period when the air injector is required to be operated.

The predetermined reference pressure may be set as the highest pressure that the air pump can generate.

The controller may determine a high-load period over a predetermined load as the period when the air injector is required to be operated.

The controller may change a time and a period for spraying compressed air through the air injector within a range after the intake valve is closed and before Top Dead Center (TDC) engine condition, depending on the operation situation of the engine.

According to the present disclosure, it is possible to improve the power of an engine, largely reduce noxious exhaust substances, and improve fuel efficiency. These results are achieved by appropriately generating swirl in desired states in the combustion chamber of an engine without increasing resistance in intake air flow in accordance with the operation states of the engine so that combustion characteristics of the engine can be considerably improved.

### BRIEF DESCRIPTION OF THE DRAWINGS

The above and other aspects, features and advantages of the present disclosure will be more apparent from the following detailed description taken in conjunction with the accompanying drawings, in which:

FIG. 1 is a diagram showing an example of a configuration of an air control apparatus for an engine according to the present disclosure;

FIG. 2 is a diagram showing a combustion chamber of an engine of FIG. 1 as viewed from above.

FIG. 3 is a graph showing operation of an air injector of FIG. 1 according to a change of a crank angle; and

FIG. 4 is a flow chart showing an embodiment of an air control method for an engine according to the present disclosure.

### DETAILED DESCRIPTION

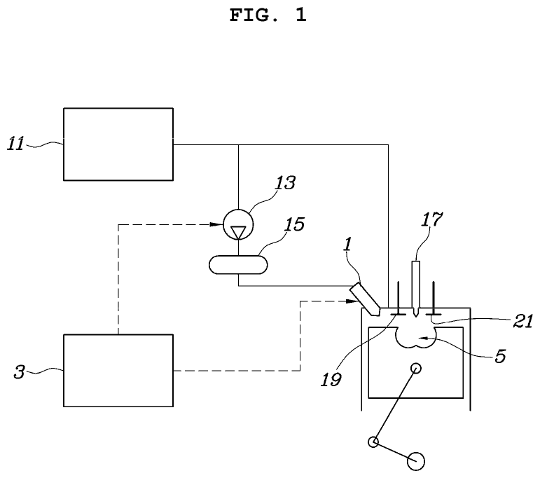

Referring to FIGS. 1-3, an air control apparatus for an engine of the present disclosure includes an air injector 1 that sprays air circumferentially into a combustion chamber The air control apparatus also includes a pneumatic pressure supplier that supplies compressed air to the air injector 1. The air control apparatus also includes a controller 3 that controls the pneumatic pressure supplier to supply compressed air to the air injector 1 after closing an intake valve of the engine.

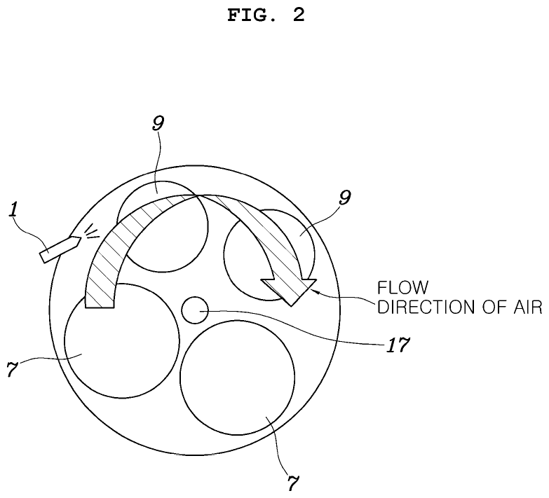

The air injector 1 is installed to be able to spray air circumferentially in the combustion chamber. In other words, compressed air discharged from the air injector 1 can be discharged at an angle in a tangential direction rather than the radial direction of the circle showing the combustion chamber 5 in FIG. 2, which shows the combustion chamber 5 from above.

The present disclosure makes it possible to forcibly generate necessary swirl in the combustion chamber 5 of the engine by spraying compressed air using the air injector 1 and to appropriately control generation of swirl in accordance with the operation situation of the engine using the controller 3.

Accordingly, the shape of an intake port for supplying intake air to the combustion chamber 5 is formed such that resistance in intake air flow can be minimized regardless of generation of swirl. Therefore, the efficiency of filling the combustion chamber 5 with intake air is increased by minimizing resistance in intake air flow. Thus, it is possible to improve the power and fuel efficiency of the engine.

The air sprayed from the air injector 1 additionally increases the amount of air filling the combustion chamber 5 to generate the swirl. Thus, more fuel can be burned and the power of the engine can be improved accordingly.

In one example, a fuel injector 17 for spraying fuel is disposed over the center of the combustion chamber 5. Also, an intake valve 19 and an exhaust valve 21 are conceptually shown at both sides of the fuel injector 17.

The air injector 1 is disposed above the combustion chamber 5 to spray compressed air toward the exhaust port 9 between an intake port 7 and the exhaust port 9.

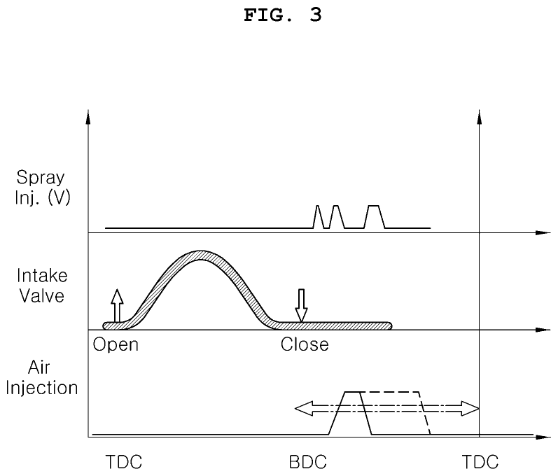

Accordingly, as shown in FIG. 3, the air injector 1 sprays compressed air immediately after the intake valve is closed. The compressed air is supplied with air that has flowed in the combustion chamber 5 through the intake port before the intake valve is closed, or the air is supplied in a similar direction to the flow direction of air flowing through the intake port by supply of the compressed air at high pressure from behind the air from the air injector 1. Swirl is thereby more smoothly generated in the combustion chamber 5.

For reference, FIG. 3 shows that the degree of opening of the intake valve increases when the intake valve opens and decreases when the intake valve closes. In FIG. 3, the top portion shows an example in which the controller 3 gives an instruction to spray compressed air into the combustion chamber 5 by opening the air injector 1. The bottom portion in FIG. 3 shows that the area to which compressed air can be sprayed from the air injector 1 reaches a range close to a TDC engine condition immediately after the intake valve is closed and the points of time at which spraying of compressed air is started and ended are variable within the range.

The pneumatic pressure supplier includes an air pump 13 that compresses air that has passed through an air cleaner 11 and that supplies the compressed air to the air injector 1. The pneumatic pressure supplier further includes an air tank 15 that keeps the compressed air produced by the air pump 13 and supplies the compressed air to the air injector 1.

That is, the compressed air to be sprayed by the air injector 1 is produced by the air pump 13. The air to be supplied to the air pump 13 is filtered through the air cleaner 11 and then supplied to the air pump 13 with impurities removed.

The air tank 15 is provided between the air pump 13 and the air injector 1, as described above, in consideration of the situation in which it is difficult for compressed air for the air injector 1 to be immediately supplied from the air pump 13. Accordingly, the air tank 15 functions as a buffer and the compressed air for the air injector 1 can be immediately, smoothly, and stably supplied.

The controller 3 controls the air injector 1 to spray compressed air into the combustion chamber 5 while the pressure in the combustion chamber 5 is lower than the pressure of the compressed air that is supplied from the air pump 13 after the intake valve of the engine is closed.

That is, for example, when the pressure of the compressed air supplied from the air pump 13 is 10 bar, the controller 3 opens the air injector 1 so that compressed air flows into the combustion chamber 5 and generates swirl therein only while the pressure in the combustion chamber 5 is less than 10 bar.

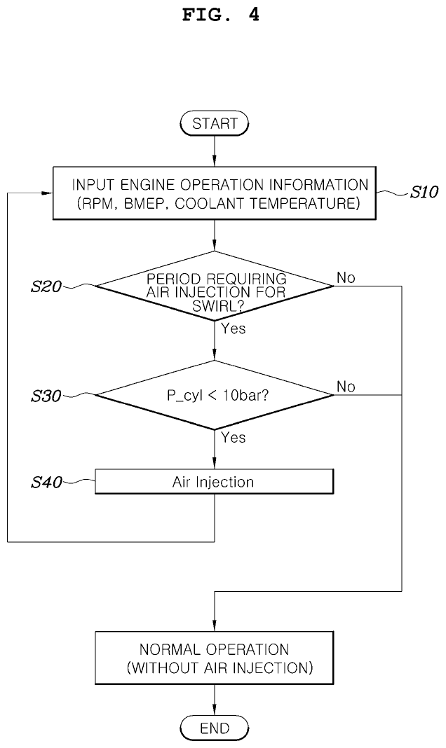

A method of controlling the air control apparatus for an engine described above in accordance with an embodiment of the present disclosure is shown in FIG. 4. The method includes receiving operation information of an engine such as engine RPM, Brake Mean Effective Pressure (BMEP), and coolant temperature by means of the controller 3 (S10). The method also includes determining whether the current operation period of the engine is a period when the air injector 1 for generating swirl is required to be operated on the basis of the received information by means of the controller 3 (S20). The method also includes generating swirl by spraying compressed air into the combustion chamber 5 by operating the air injector 1 by means of the controller 3 when it id determined that the air injector 1 is required to be operated (S40).

That is, the controller 3 receives operation information of the engine, determines whether the current operation period of the engine is a period when the air injector 1 is required to be operated, and then operates the air injector 1 to spray compressed air into the combustion chamber 5 when determining that the current operation period of the engine corresponds to the period when the air injector 1 is required to be operated. Swirl can thus be forcibly and actively generated in the combustion chamber 5.

The method further includes comparing the pressure in the combustion chamber 5 with a predetermined reference pressure so that the controller 3 operates the air injector 1 to spray compressed air into the combustion chamber 5 only when the combustion chamber pressure P_cyl is less than the predetermined reference pressure even though the controller 3 determines that the current operation period of the engine corresponds to the period when the air injector 1 is required to be operated.

That is, the reference pressure may be set as the highest pressure that the air pump 13 can generate, such as 10 bar. The controller 3 does not open the air injector 1 when the combustion chamber pressure P_cyl is the reference pressure or more, even though the controller determines that the operation state of the engine corresponds to the period when the air injector 1 is required to be operated to generate swirl.

Further, the controller 3 may generate swirl through the air injector 1 by determining a high-load period over a predetermined load as the period when the air injector 1 is required to be operated.

That is, for example, one may assume that it is the reference load is when a driver depresses an accelerator pedal about 50% and that it is a high-load period when the driver depresses the accelerator pedal over 50%. The controller 3 operates the air injector 1 such that swirl is forcible generated in the combustion chamber 5, thereby further improving the power of the engine.

The controller 3 may change the time and the period for spraying compressed air through the air injector 1 within the range after the intake valve is closed and before TDC, depending on the operation situation of the engine, as shown in FIG. 3.

Although the present disclosure is described with reference to specific embodiments shown in the drawings, it will be apparent to those having ordinary skill in the art that the present disclosure may be changed and modified in various ways without departing from the scope of the present disclosure, which is described in the following claims.

What is claimed is:

1. An air control apparatus for an engine, the apparatus comprising:
an air injector that sprays air circumferentially into a combustion chamber;
a pneumatic pressure supplier that supplies compressed air to the air injector; and
a controller that controls the pneumatic pressure supplier to supply compressed air to the air injector after closing an intake valve of the engine.

2. The apparatus of claim 1, wherein the air injector is disposed above the combustion chamber to spray compressed air toward an exhaust port between an intake port and the exhaust port.

3. The apparatus of claim 2, wherein the pneumatic pressure supplier includes an air pump that compresses air that has passed through an air cleaner and supplies the compressed air to the air injector.

4. The apparatus of claim 3, wherein the pneumatic pressure supplier further includes an air tank that keeps the compressed air produced by the air pump and supplies the compressed air to the air injector.

5. The apparatus of claim 3, wherein the controller controls the air injector to spray compressed air into the combustion chamber while pressure in the combustion chamber is lower than pressure of the compressed air that is supplied from the air pump after the intake valve of the engine is closed.

6. A method of controlling the air control apparatus for the engine of claim 5, the method comprising:
receiving operation information of the engine by means of the controller;
determining whether the current operation period of the engine is a period when the air injector for generating swirl is required to be operated on the basis of the received information by means of the controller; and
generating swirl by spraying compressed air into the combustion chamber by operating the air injector by means of the controller when it is determined that the air injector is required to be operated.

7. The method of claim 6, further comprising:
comparing combustion chamber pressure with a predetermined reference pressure so that the controller operates the air injector to spray compressed air into the combustion chamber only when the combustion chamber pressure is less than the predetermined reference pressure even though the controller determines that the current operation period of the engine corresponds to the period when the air injector is required to be operated.

8. The method of claim 7, wherein the predetermined reference pressure is set as the highest pressure that the air pump can generate.

9. The method of claim 7, wherein the controller determines a high-load period over a predetermined load as the period when the air injector is required to be operated.

10. The method of claim 7, wherein the controller changes a time and a period for spraying compressed air through the air injector within a range after the intake valve is closed and before a Top Dead Center (TDC) engine condition, depending on the operation situation of the engine.

11. The method of claim 6, wherein the spraying compressed air is to be performed from between an intake port and an exhaust port toward the exhaust port.
